(19) United States
(12) Patent Application Publication
(10) Pub. No.: US 2024/0302535 A1
(43) Pub. Date: Sep. 12, 2024

(54) COLLABORATIVE DIFFERENTIAL GLOBAL NAVIGATION SATELLITE SYSTEM (GNSS)

(71) Applicant: Albora Technologies Limited, London (GB)

(72) Inventors: Helena Calatrava, Barcelona (ES); Adrià Gusi, Calella (ES); Ernest Artiaga, Barcelona (ES); Pau Closas, Westborough, MA (US)

(73) Assignee: Albora Technologies Limited, London (GB)

(21) Appl. No.: 18/120,389

(22) Filed: Mar. 11, 2023

(51) Int. Cl. G01S 19/07

(52) U.S. Cl. CPC G01S 19/071; G01S 19/072

(57) ABSTRACT

Differential global navigation satellite system (GNSS) positioning includes establishing a communicative coupling between a central computing node and a multiplicity of different roving receivers disposed within a geographic region of common atmospheric error. Each of the different roving receivers generates observable data from GNSS signals received from different ones of a selection of satellites in a GNSS constellation accessible from the geographic region of common atmospheric error. Differential GNSS additionally includes collecting the observable data from the different roving receivers in memory of the central computing node and computing a position of a specific one of the different roving receivers based upon a reduction of error determined from differencing performed upon the collected observable data from others of the different roving receivers. Finally, differential GNSS includes transmitting the computed position over the communicative coupling to the specific one of the roving receivers.

### BACKGROUND OF THE INVENTION

### Field of the Invention

The present invention relates to the technical field of global navigation satellite system (GNSS) position determination in satellite-based global positioning systems.

### Description of the Related Art

Satellite-based positioning refers to the position, velocity and time (PVT) determination for a GNSS receiver according to GNSS positioning data within signals such as those produced by the global positioning system (GPS), Global Navigation Satellite System (GLONASS), Galileo, NavIC and BeiDou. The core signal for GNSS is a direct-sequence spread-spectrum signal, synchronously transmitted by each satellite in a GNSS satellite constellation. The spread-spectrum signal includes both a ranging code, also referred to as the pseudorandom noise (PRN) spreading sequence, and also a low-rate data-link which broadcasts ephemeris information for the corresponding satellite.

Each GNSS receiver receives the GNSS signal from which the GNSS receiver estimates PVT. To do so, programmatic logic executing in coordination with the GNSS receiver estimates the ranging code in the signal model so as to construct a set of observables for each satellite from which the GNSS signal had been received. The observables in the set includes a series of ranges computed from the time delay of the receipt of the corresponding GNSS signal, referred to as pseudoranges, and also phase-difference estimates, referred to as carrier-phase measurements, between the different GNSS signals. With the observables, computing PVT is a matter of solving for a multilateration of the observables within an algorithm that is typically implemented as a least squares estimator or a Kalman filter. When considering carrier-phase observables, additional computations are needed to estimate integer ambiguity, ultimately increasing the sensitivity of the receiver.

Traditionally, the computation of PVT is a two-step process. The first step of the process produces a coarse estimate of synchronization parameters based upon the unpolished received signal data. Additionally, this first step might involve a refinement of the coarse estimate utilizing either finer acquisition or tracking loops. More precisely, in the first step, estimates of time delay and Doppler shifts are determined from the spread spectrum signals received from a selection of the satellites. In the second step, referred to as the “navigation solution”, the GNSS observables are processed in order to estimate PVT of the GNSS receiver.

Differential GNSS is a process by which observables from a GNSS base station for whom its position is accurately known, are combined to the observables of a roving receiver in order to reduce common errors. These errors include ionospheric and tropospheric delays, or satellite clock biases. This differentiation process can be done through several combinations of observables: pseudorange measurements only, or pseudorange and carrier-phase measurements. The latter is often referred to as “Real Time Kinematics” or RTK. In RTK, for instance, the positioning errors can be mitigated to achieve sub-centimeter positioning, as compared to meter-level accuracy of non-RTK solutions. Thus, integral to differential GNSS is the precise knowledge of the coordinates of the base station with which the observables are combined with the observables of the roving receiver. However, if both the roving receiver and the base station have unknown positions, the traditional process of differential GNSS cannot be implemented.

### BRIEF SUMMARY OF THE INVENTION

Embodiments of the present invention address technical deficiencies of the art in respect to differential GNSS. To that end, embodiments of the present invention provide for a novel and non-obvious method for differential GNSS positioning with observables collected from different receivers co-located within a geographic space of common atmospheric error. Embodiments of the present invention also provide for a novel and non-obvious computing device adapted to perform the foregoing method. Finally, embodiments of the present invention provide for a novel and non-obvious data processing system incorporating the foregoing device in order to perform the foregoing method.

In one embodiment of the invention, a method for differential GNSS positioning includes establishing a communicative coupling between a central computing node and a multiplicity of different roving receivers disposed within a geographic region of common atmospheric error. Each of the different roving receivers generates observable data from GNSS signals received from different ones of a selection of satellites in a GNSS constellation accessible from the geographic region of common atmospheric error. The method additionally includes collecting the observable data from the different roving receivers in memory of the central computing node and computing a position of a specific one of the different roving receivers based upon a reduction of error determined from differencing performed upon the collected observable data from others of the different roving receivers. Finally, the method includes transmitting the computed position over the communicative coupling to the specific one of the roving receivers.

In one aspect of the embodiment, the error pertains to transmission delays owing to atmospheric delays of the geographic region of common atmospheric error. In another aspect of the embodiment, the error pertains to satellite clock bias. In either circumstance, the computed position accounts for correction of the error using a combination of the observable data based upon either or both of pseudorange and pseudorange+carrier-phase. To that end, the observable data can be additionally collected from at least one base station geographically proximate to the different roving receivers. As well, in another aspect of the embodiment, the observable data can be collected in a queue filtered according to a maximum lapsed period of time from collection of the observable data.

In another embodiment of the invention, a data processing system is adapted for differential GNSS positioning. The system includes a central computing node that has a host computing platform of one or more computers, each with memory and one or more processing units, each of the processing units including one or more processing cores. The system further includes a positioning module that includes computer program instructions enabled while executing in the memory of at least one of the processing units of the host computing platform to perform differential GNSS positioning based upon a collection of observable data from different receivers within a geographic region of common atmospheric error.

Specifically, upon execution, the program instructions are enabled to establish a communicative coupling between the central computing node and different roving receivers disposed within a geographic region of common atmospheric error, each generating observable data from GNSS signals received from different satellites in a GNSS constellation. The program instructions additionally are enabled to collect the observable data from the different roving receivers in the memory of the central computing node and compute a position of a specific one of the different roving receivers based upon a reduction of error determined from differencing performed upon the collected observable data from others of the different roving receivers. Finally, the program instructions are enabled to transmit the computed position over the communicative coupling to the specific one of the roving receivers.

In this way, the technical deficiencies of differential GNSS when the precise location of the base station is unknown can be overcome owing to the leveraging of a multiplicity of roving receivers communicating with the single, central node. Additionally, even when the position of a base station is well-known, the joint estimation of the positions of all collaborative roving receivers can improve the overall performance of the RTK system.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration reflecting different aspects of a process of differential GNSS positioning with observables collected from different receivers co-located within a geographic space of common atmospheric error;

FIG. 2 is a block diagram depicting a data processing system adapted to perform one of the aspects of the process of FIG. 1; and,

FIG. 3 is a flow chart illustrating one of the aspects of the process of FIG. 1.

### DETAILED DESCRIPTION OF THE INVENTION

Embodiments of the invention provide for differential GNSS positioning with observables collected from different receivers co-located within a geographic space of common atmospheric error. In accordance with an embodiment of the invention, GNSS observables are collected in a central computing node from over a computer communications network from different roving receivers present within a geographic area having common atmospheric error experienced by each of the receivers. The observables are then differenced to determine error reduction then included in the computation of a position of a specific one of the roving receivers. Finally, the computed position is transmitted to the specific one of the roving receivers.

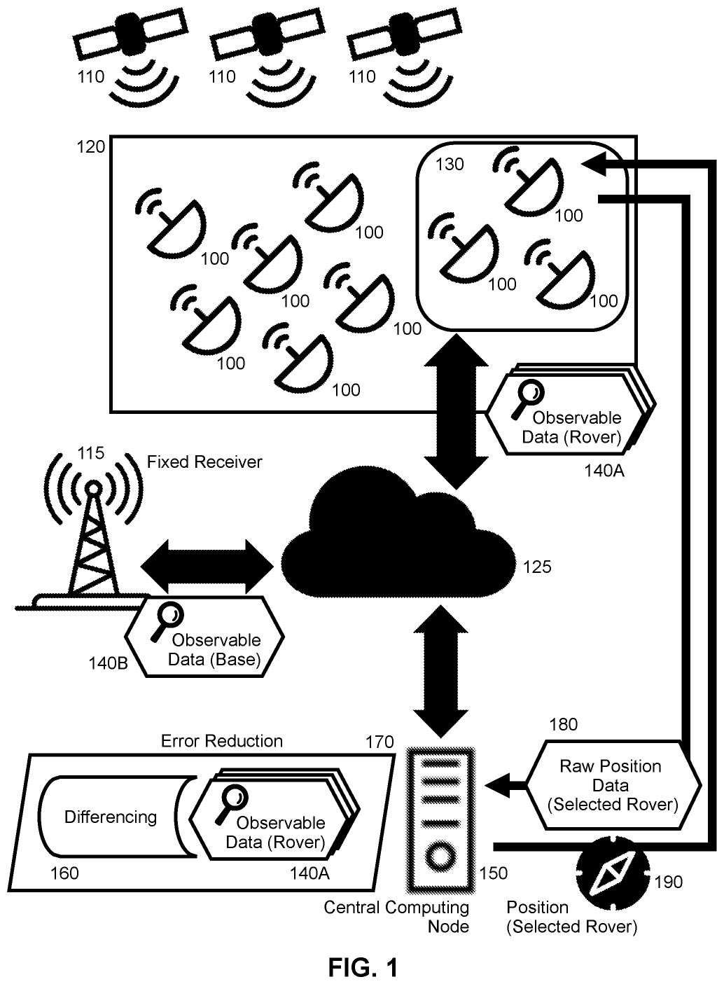

In illustration of one aspect of the embodiment, FIG. 1 pictorially shows a process of differential GNSS positioning. As shown in FIG. 1, different roving receivers 100 disposed within a geographic area 120 receiving positioning information from positioning satellites 110 including observables used in computing an error in the positioning information. One of the roving receivers 100 within a portion 130 of the geographic area 120 having common atmospheric error experienced by others of the roving receivers 100 within the portion 130 provide observable data 140A over data communications network 125 to a central computing node 150.

With the observable data 140A, the central computing node 150 determines the error reduction 170 for the one of the roving receivers 100 in order to correct the raw position data 180 received in the central computing node 150. The central computing node 150 determines the error reduction 170 through a pair-wise differencing 160 of pairs of the observable data 140A for corresponding pairs of the others of the roving receivers 100 in the portion 130 of the geographical area 120. The result is an accurate position 190 of the one of the roving receivers 100. The central computing node 150 then returns transmission of the accurate position 190 to the one of the roving receivers 100. Optionally, the observable data 140B of a fixed receiver 115 can be included in the differencing 160, or the error reduction 170 can be composited with that of the fixed receiver 115 in order to produce the position 190 for the one of the roving receivers 100.

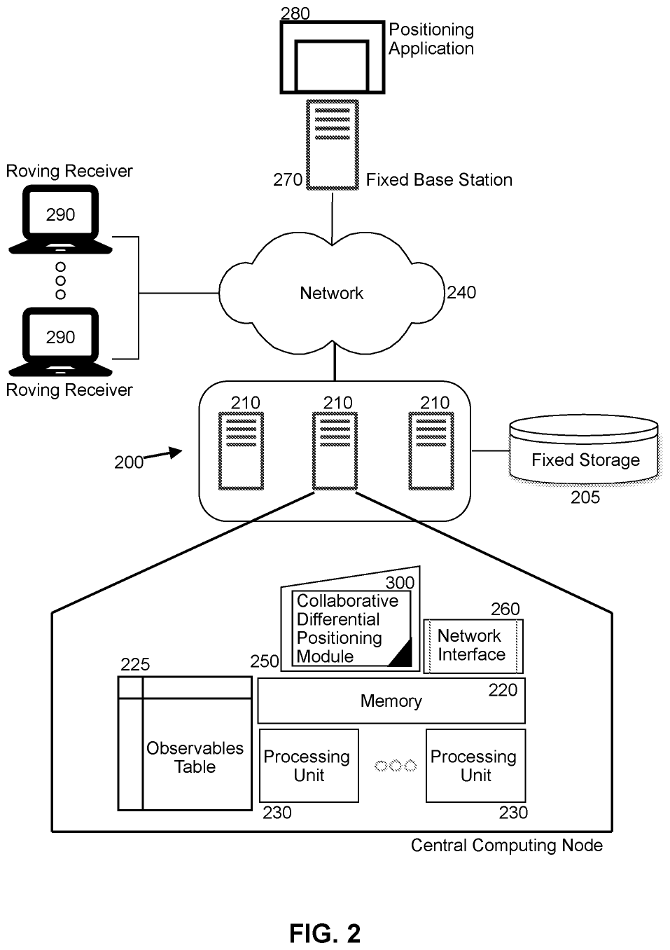

Aspects of the process described in connection with FIG. 1 can be implemented within a data processing system. In further illustration, FIG. 2 schematically shows a data processing system adapted to perform differential GNSS positioning. In the data processing system illustrated in FIG. 1, a host computing platform 200 is provided. The host computing platform 200 includes one or more computers 210, each with memory 220 and one or more processing units 230 and defining a central computing node. The computers 210 of the host computing platform can be co-located within one another and in communication with one another over a local area network, or over a data communications bus, or the computers can be remotely disposed from one another and in communication with one another through network interface 260 over a data communications network 240.

Notably, a computing device 250 including a non-transitory computer readable storage medium can be included with the data processing system 200 and accessed by the processing units 230 of one or more of the computers 210. The computing device stores 250 thereon or retains therein a program module 300 that includes computer program instructions which when executed by one or more of the processing units 230, performs a programmatically executable process for differential GNSS positioning. Specifically, the program instructions during execution receive observables from different roving receivers 290 from over the data communications network 240. The observables are then stored by the program instructions in fixed storage 205 which may include any form of persistent storage from which the observables may then be loaded into an observables table 225 in the memory 220. Alternatively, the observables may be directly stored in the memory 220 without persistence in the fixed storage 205.

The observables can include the traveling time of the signal experienced during propagation from the phase center of an antenna of a transmitting satellite at the time of emission, to the phase center of the receiver of a corresponding one of the roving receivers 290, at the time of reception, and can include pseudorange measurements only, or both pseudorange measurements and carrier-phase measurements. Each of the observables can be stored in the observables table in connection with an identifier of the corresponding one of the roving receivers 290 and a last known position of the corresponding one of the roving receivers 290. Optionally, observables may also be received and stored in respect to a fixed base station 270 including a positioning application 280 cooperating with the roving receivers 290.

Of note, at any time, a selected one of the roving receivers 290 may receive raw positioning data from a set of positioning satellites which the selected one of the roving receivers 290 may then provide over the data communications network 240 through the network interface 260 to the collaborative differential positioning module 300. The program instructions of the module 300 then filter the observables in the observables table 225 to a sub-set of only those of the observables corresponding to ones of the roving receivers 290 within geographic proximity of the selected one of the roving receivers 290 and within a geographical area of common atmospheric error in transmission of GNSS signals from the positioning satellites owing, for instance, to ionospheric or tropospheric delays experienced at the geographical area. Optionally, the sub-set can be further filtered to include observables corresponding to only ones of the roving receivers 290 determined to be within a threshold distance of one another.

Thereafter, the program instructions compute pairwise differences between the observables of pairs of the sub-set in order to determine a joint estimation of error, for instance according to a least-squares computation of the pair-wise differences. The program instructions then correct the raw positioning data joint with the joint estimation of error in order to return the correct position of the selected one of the roving receivers 290 to the selected one of the roving receivers 290 through the network interface 260 over the data communications network. In this way, the joint estimation of error determined based upon a crowd of the roving receivers 290 within a common geographic area can replace the necessity for interacting with a fixed base station in computing centimeter precise positioning data for the selected one of the roving receivers 290.

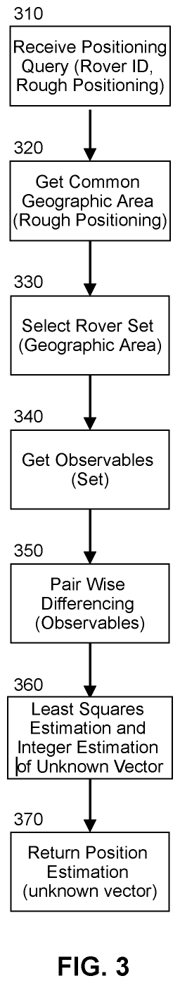

In further illustration of an exemplary operation of the module, FIG. 3 is a flow chart illustrating one of the aspects of the process of FIG. 1. Beginning in block 305, a positioning query is received from a transmitting one of several roving receivers disposed within a geographic area and communicating with different GNSS satellites in a GNSS satellite constellation. An identifier is determined for the transmitting one of the several roving receivers along with a rough position estimate. In block 320, then, a geographic area of common atmospheric error is determined based upon the rough position estimate. In this regard, the geographic area of common atmospheric error can be identified according to an area in which signals transmitted to all ones of the roving receivers therein are subjected to the same atmospherically influenced error, such as a similar ionospheric or tropospheric delays or similar satellite clock bias.

Thereafter, in block 330, a set of others of the several roving receivers known to be positioned within the geographic area are selected and in block 340, observables stored in connection with the set of the others of the several roving receivers are retrieved. Optionally, the observables may then be filtered to include only those of the observables with a time stamp of threshold recency. Subsequently, in block 350, a pair wise differencing is performed on different pairs of the retrieved observables and in block 360, an ambiguity resolution process commences, which can vary depending upon whether or not the observables refer only to pseudorange measurements, or to both pseudorange measurements and carrier phase measurements.

To the extent that the observables refer only to pseudorange measurements, a real valued least squared estimation, or in the alternative, a Kalman filter, of unknown is performed on the result of the pairwise differencing in order to produce a joint estimation of error. Alternatively, when the observables refer both to pseudorange measurements and carrier phase measurements, integer ambiguity fixing is performed through an integer least squares estimation in addition to real least squares estimation, as it is understood in the art. Finally, in block 370, the rough position estimate is corrected with the joint estimation of error in order to produce a fine position estimate for the transmitting one of the roving receivers. Thereafter, the fine position estimate is returned to the transmitting one of the roving receivers.

The foregoing flowchart and block diagram referred to herein illustrate the architecture, functionality, and operation of possible implementations of systems, methods, and computing devices according to various embodiments of the present invention. In this regard, each block in the flowchart or block diagrams may represent a module, segment, or portion of instructions, which includes one or more executable instructions for implementing the specified logical function or functions. In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

More specifically, the present invention may be embodied as a programmatically executable process. As well, the present invention may be embodied within a computing device upon which programmatic instructions are stored and from which the programmatic instructions are enabled to be loaded into memory of a data processing system and executed therefrom in order to perform the foregoing programmatically executable process. Even further, the present invention may be embodied within a data processing system adapted to load the programmatic instructions from a computing device and to then execute the programmatic instructions in order to perform the foregoing programmatically executable process.

To that end, the computing device is a non-transitory computer readable storage medium or media retaining therein or storing thereon computer readable program instructions. These instructions, when executed from memory by one or more processing units of a data processing system, cause the processing units to perform different programmatic processes exemplary of different aspects of the programmatically executable process. In this regard, the processing units each include an instruction execution device such as a central processing unit or “CPU” of a computer. One or more computers may be included within the data processing system. Of note, while the CPU can be a single core CPU, it will be understood that multiple CPU cores can operate within the CPU and in either instance, the instructions are directly loaded from memory into one or more of the cores of one or more of the CPUs for execution.

Aside from the direct loading of the instructions from memory for execution by one or more cores of a CPU or multiple CPUs, the computer readable program instructions described herein alternatively can be retrieved from over a computer communications network into the memory of a computer of the data processing system for execution therein. As well, only a portion of the program instructions may be retrieved into the memory from over the computer communications network, while other portions may be loaded from persistent storage of the computer. Even further, only a portion of the program instructions may execute by one or more processing cores of one or more CPUs of one of the computers of the data processing system, while other portions may cooperatively execute within a different computer of the data processing system that is either co-located with the computer or positioned remotely from the computer over the computer communications network with results of the computing by both computers shared therebetween.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for differential global navigation satellite system (GNSS) positioning, the method comprising:
establishing a communicative coupling between a central computing node and a multiplicity of different roving receivers disposed within a geographic region of common atmospheric error, each of the different roving receivers generating observable data from GNSS signals received from different ones of a selection of satellites in a GNSS constellation;
collecting the observable data from the different roving receivers in memory of the central computing node and computing a position of a specific one of the different roving receivers based upon a reduction of error determined from differencing performed upon the collected observable data from others of the different roving receivers; and,
transmitting the computed position over the communicative coupling to the specific one of the roving receivers.

2. The method of claim 1, wherein the error pertains to transmission delays owing to atmospheric delays of the geographic region of common atmospheric error.

3. The method of claim 1, wherein the error pertains to satellite clock bias.

4. The method of claim 1, wherein the computed position accounts for correction of the error using a combination of the observable data based upon either or both of pseudorange and pseudorange+carrier-phase.

5. The method of claim 1, wherein the observable data is additionally collected from at least one base station geographically proximate to the different roving receivers.

6. The method of claim 1, wherein observable data is collected in a queue filtered according to a maximum lapsed period of time from collection of the observable data.

7. A data processing system adapted for differential global navigation satellite system (GNSS) positioning, the system comprising:
a central computing node comprising a host computing platform of one or more computers, each with memory and one or processing units including one or more processing cores; and,
a positioning module comprising computer program instructions enabled while executing in the memory of at least one of the processing units of the host computing platform to perform:
establishing a communicative coupling between the central computing node and a multiplicity of different roving receivers disposed within a geographic region of common atmospheric error, each of the different roving receivers generating observable data from GNSS signals received from different ones of a selection of satellites in a GNSS constellation;
collecting the observable data from the different roving receivers in the memory of the central computing node and computing a position of a specific one of the different roving receivers based upon a reduction of error determined from differencing performed upon the collected observable data from others of the different roving receivers; and, transmitting the computed position over the communicative coupling to the specific one of the roving receivers.

8. The system of claim 7, wherein the error pertains to transmission delays owing to atmospheric delays of the geographic region of common atmospheric error.

9. The system of claim 7, wherein the error pertains to satellite clock bias.

10. The system of claim 7, wherein the computed position accounts for correction of the error using a combination of the observable data based upon either or both of pseudorange and pseudorange+carrier-phase.

11. The system of claim 7, wherein the observable data is additionally collected from at least one base station geographically proximate to the different roving receivers.

12. The system of claim 7, wherein observable data is collected in a queue filtered according to a maximum lapsed period of time from collection of the observable data.

13. A computing device comprising a non-transitory computer readable storage medium having program instructions stored therein, the instructions being executable by at least one processing core of a processing unit to cause the processing unit to perform differential global navigation satellite system (GNSS) positioning by:
establishing a communicative coupling between a central computing node and a multiplicity of different roving receivers disposed within a geographic region of common atmospheric error, each of the different roving receivers generating observable data from GNSS signals received from different ones of a selection of satellites in a GNSS constellation;
collecting the observable data from the different roving receivers in memory of the central computing node and computing a position of a specific one of the different roving receivers based upon a reduction of error determined from differencing performed upon the collected observable data from others of the different roving receivers; and,
transmitting the computed position over the communicative coupling to the specific one of the roving receivers.

14. The device of claim 13, wherein the error pertains to transmission delays owing to atmospheric delays of the geographic region of common atmospheric error.

15. The device of claim 13, wherein the error pertains to satellite clock bias.

16. The device of claim 13, wherein the computed position accounts for correction of the error using a combination of the observable data based upon either or both of pseudorange and pseudorange+carrier-phase.

17. The device of claim 13, wherein the observable data is additionally collected from at least one base station geographically proximate to the different roving receivers.

18. The device of claim 13, wherein observable data is collected in a queue filtered according to a maximum lapsed period of time from collection of the observable data.
